(19) United States
(12) Patent Application Publication
(10) Pub. No.: US 2026/0129720 A1
(43) Pub. Date: May 7, 2026

(54) CATALYTICALLY ACTIVE HEATING ELEMENTS, PRODUCTION AND USE THEREOF

(71) Applicant: Evonik Operations GmbH, Essen (DE)

(72) Inventors: Ulf Bindernagel, Koeln (DE); Catrin Dorothee Becker, Frankfurt (DE); Thomas Müller, Altenstadt (DE); Martin Köstner, Darmstadt (DE)

(73) Assignee: Evonik Operations GmbH, Essen (DE)

(21) Appl. No.: 19/118,406

(22) PCT Filed: Sep. 14, 2023
(86) PCT No.: PCT/EP2023/075246

§ 371 Date: Apr. 4, 2025

(30) Foreign Application Priority Data
Oct. 7, 2022 (EP) 22200202.4

(51) Int. Cl. H05B 3/44; B01J 12/00; B01J 19/00; B01J 19/24; B01J 23/42; C01C 3/02

(52) U.S. Cl. CPC H05B 3/44; B01J 12/007; B01J 19/0013; B01J 19/24; B01J 23/42; C01C 3/0225; C01C 3/0229; B01J 2219/00135

(57) ABSTRACT

The invention relates to catalytically active heating elements, and to the production and use thereof in the production of hydrogen cyanide (HCN). The problem addressed by the invention is that of providing thermally stable and catalytically active heating elements with which a BMA process can be simultaneously electrically heated and chemically catalysed. In particular, the heating elements should be thermally and mechanically stable in continuous industrial operation and retain their catalytic activity. The heating element according to the invention has a layered structure (A, B, C) formed from (A) silicon carbide (SiC), (B) aluminium nitride (AlN) and (C) platinum (Pt). The silicon carbide (SiC) serves as an electric heating resistor. The platinum (Pt) serves as catalyst. Aluminium nitride (AIN) is arranged as a protective layer between platinum (Pt) and silicon carbide (SiC). It prevents platinum (Pt) and silicon carbide (SiC) from alloying during ongoing operation.

The invention relates to catalytically active heating elements and to the production and use thereof in hydrocyanic acid production.

Hydrocyanic acid (HCN), the simplest nitrile, is an important synthesis unit in organic chemistry. It is traditionally employed in metal extraction and processing. On an industrial scale the production of hydrocyanic acid is usually carried out by the Andrussow process or the BMA process.

An introduction to the technology of hydrocyanic acid production may be found in:
Gail, E., Gos, S., Kulzer, R., Lorösch, J., Rubo, A., Sauer, M., Kellens, R., Reddy, J., Steier, N. and Hasenpusch, W. (2011). Cyano Compounds, Inorganic. In Ullmann's Encyclopedia of Industrial Chemistry, (Ed.). https://doi.org/10.1002/14356007.a08_159.pub3

In the BMA process (BMA=“Blausäure aus Methan und Ammoniak” [hydrocyanic acid from methane and ammonia]) hydrocyanic acid is produced from methane (CH₄) and ammonia (NH₃) in a strongly endothermic reaction which requires relatively high reaction temperatures of 1000° C.-1300° C. In contrast to the Andrussow process the BMA process is performed in the absence of oxygen.

The energy required in the BMA process is provided in a separate combustion space through combustion of heating gas. Only a portion of the employed heating energy may be utilized for the reaction itself due to the necessary minimum temperatures for the hydrocyanic acid reaction. The necessary use of fossil energy carriers for providing the reaction enthalpy in conjunction with the low energetic yield for the hydrocyanic acid results in significant generation of CO₂.

As an alternative energy source HCN may be produced with electrical energy instead of with fossil fuels. When using electricity from renewable sources the process is potentially very largely CO₂-neutral. An electrically heated BMA process also has further advantages over a BMA process heated with fossil fuel, for example in terms of running costs:
By avoiding the entailed energy loss on the fuel gas side due to the high minimum reaction temperature necessary, a better energetic efficiency is to be expected.
Since refractory materials for lining the reactor need not be employed, faster startup and shutdown cycles are achieved.
A more homogeneous temperature mode makes it possible to achieve higher yields, thus reducing the specific usage amounts of methane and ammonia for hydrocyanic acid production. This is because it is known that homogeneous temperature distribution makes it possible to achieve markedly higher yields coupled with lower byproduct formation.

In terms of capital costs too, an electrically heated BMA plant has advantages over a thermally heated plant:
The absence of fuel gas and flue gas spaces allows a more compact construction and higher space-time yields
and cost-effective modular interconnections are likewise possible.

Finally, an electrically operated BMA process is more sustainable:
The generated hydrogen-containing residual gas may optionally substitute natural gas as heating gas in downstream processes, thus achieving an additional CO₂ reduction.
The hydrogen in the generated residual gas has a considerably lower CO₂ footprint than hydrogen produced from fossil hydrocarbons in the steam reformer and may be used as raw material for further chemical reactions after a potentially required purification.

For all these reasons there is an interest in developing a BMA process operated with electrical energy, by which hydrocyanic acid may be produced on an industrial scale.

Various concepts for producing HCN in electrically heated reactors are known:
Hydrocyanic acid production through the use of electrically heated fixed bed reactors is described, wherein the heating of the catalyst dumped bed may be effected by induction; cf. WO 2017186437 A1.

Structured catalyst bodies, so-called monoliths, composed of electrically conductive material as described in DE 10317197A1, WO 2019228798 A1 or WO 2021/063799 A1 are also employed. In the recited publications the reactants are passed through the catalyst-coated channels of an electrically heated structure.

Similarly, WO 2022017900 A1 describes catalytically active heating elements produced by additive manufacturing which are to be employed in various endothermic reactions including in hydrocyanic acid production. The heating elements comprise a metallic, electrically conductive core provided with a ceramic coating. A catalytically active layer has in turn been applied to the ceramic coating. In the context of the Andrussow process the catalytically active layer contains Pt, Co or SnCo. However, details about the composition of the ceramic layer in respect of hydrocyanic acid production are lacking. Recited in the context of steam reforming are ceramic layers composed of Al₂O₃, ZrO₂, MgAl₂O₄, CaAl₂O₄, to which catalytically active material composed of Ni, Ru, Rh, Ir is applied.

A disadvantage of the additively manufactured heating elements is in principle that the choice of material for the metallic cores is limited.

The utilization of catalytic heating rods for the production of hydrocyanic acid by the BMA reaction is described in NL 121661 and WO 9615983A1 : these employ graphite or silicon carbide tubes as electrically conducting elements, on whose inner surfaces platinum has been applied as catalyst.

A silicon carbide tube having a directly applied platinum catalyst is not an advantageous combination for the BMA reaction. This is because it is known that at temperature ranges relevant for the BMA process a eutectic mixture between silicon carbide and platinum is formed:
L. L. Xu, J. Wang, H. S. Liu, Z. P. Jin: Thermodynamic assessment of the Pt—Si binary system. Calphad, Volume 32, Issue 1, 2008, Pages 101-105.
https://doi.org/10.1016/j.calphad.2007.07.010

This has the result that the platinum forms an alloy with the silicon and the catalytic coating loses adhesion at the high reaction temperatures required in the BMA process. Catalysis is impaired.

US 20170106360 A1 also employs catalytic heating rods, wherein here the heating rods themselves are composed of catalytic material or the heating rods are coated with catalyst or initially a separating layer, a so-called ‘washcoat’, is applied and then the catalyst is applied as a further layer. A eutectic mixture between SiC and Pt may likewise be formed in the case of rods of silicon carbide (SiC) with directly applied platinum (Pt) as catalyst for BMA reaction. A separating layer between the heating rod and the catalyst is therefore mandatory in the case of the combination of platinum-containing catalysts and heating rods composed of silicon carbide for the BMA process. US 20170106360 A1 also describes such a construction with a separating layer (‘washcoat’) composed of the material Al₂O₃. However, it is known that the coefficient of thermal expansion of Al₂O₃(˜8*10⁻⁶ K⁻¹ at 600° C.) is markedly greater than that of silicon carbide (˜5*10⁻⁶ K⁻¹ at 600° C.). It is therefore to be expected that the separating layer comprising Al₂O₃ will flake off from the silicon carbide in the case of elevated temperature and/or temperature changes.

The prior art catalytically active heating elements are thus altogether unconvincing.

It is accordingly an object of the invention to provide thermally stable and catalytically active heating elements which allow simultaneous electrical heating and chemical catalysis of a BMA process. In particular the heating elements shall be thermally and mechanically stable and retain their catalytic activity in continuous industrial operation. Comparable catalytic heating rods are known from US 2017/314441 A1 and EP 1 945 345B1.

This object is achieved by a heating element having the following features:
a) a first electrical connection;
b) a second electrical connection;
c) a solid or hollow core containing silicon carbide, wherein the core electrically connects the first connection at least to the second connection;
d) a protective coating applied to the core and containing aluminium nitride;
e) a catalyst system applied to the protective coating, wherein the catalyst system contains platinum.

The invention firstly provides such a heating element.

The heating element according to the invention has a layer construction A, B, C composed of (A) silicon carbide, (B) aluminium nitride and (C) platinum-containing catalyst. The silicon carbide serves as an electrical heating resistor. Aluminium nitride is arranged as a protective layer between the catalyst layer and the silicon carbide. It prevents platinum and silicon carbide alloying during ongoing operation. Since aluminium nitride has a similar coefficient of thermal expansion to silicon carbide (˜5*10⁻⁶ K⁻¹ at 600° C.) stresses in the layer construction brought about by differing thermal expansion may be neglected. Aluminium nitride (AlN) exhibits chemically neutral behaviour in the hydrocyanic acid reaction and therefore does not impair the reaction.

It is preferable when the catalyst coating is applied exclusively to the protective coating. This prevents formation of a eutectic mixture between SiC and Pt.

The protective coating and the catalyst coating are optimally made very thin compared to the core. Specifically, the volume v₁ of the protective coating and/or the volume v₂ of the catalyst coating should be smaller than the volume v₀ of the core. The core requires a correspondingly larger volume v₀ to allow it to conduct a large current despite the high specific electrical resistance.

The heating element may be hollow or made of solid material and may have different shapes, optionally the shape of a cylindrical tube. The tube may be bent. The heating element has electrical connections and may be operated with two-phase or three-phase direct or alternating current.

The invention secondly provides for production of the heating elements according to the invention. Said production comprises at least the steps of:
a) providing a core containing silicon carbide;
b) providing a coating composition containing aluminium and nitrogen;
c) providing a catalyst system containing platinum;
d) coating the core with the coating composition to obtain a protective coating containing aluminium nitride adhering to the core;
e) coating the protective coating with the catalyst system so that the catalyst system adheres to the protective coating.

According to the invention the protective coating and then the catalyst coating are applied to the core consecutively.

According to the invention the protective coating contains aluminium nitride. The coating composition must therefore contain aluminium and nitrogen. The aluminium and the nitrogen may be applied in elemental form or in the form of a compound, including with themselves. The coating composition preferably contains aluminium nitride dispersed in a dispersion medium.

The applying of the protective coating is then carried out by purely physical means in a coating process. Various methods are conceivable for the coating of the cores. The simplest method is an immersion process. The core is immersed in the coating composition and removed therefrom again. A spraying process is likewise conceivable. Printing, sputtering, rollering or brushing would be further methods but suitable only under limited circumstances.

In all cases a drying is subsequently carried out so that the dispersion medium is evaporated and the aluminium nitride adheres to the silicon carbide.

It is alternatively also possible to employ a reactive process. To this end the coating composition employed is a system which comprises aluminium, preferably in metallic form, as the first component. As the second component the system comprises nitrogen, preferably as gas or as nitrogen-containing gas.

For coating the aluminium is initially applied to the core and then exposed to the nitrogen. In the simplest case this is achieved by exposing the aluminium-coated core to an atmosphere containing gaseous nitrogen or nitrogen-containing gas. In the presence of the core the nitrogen reacts with the aluminium to afford aluminium nitride. If necessary the atmosphere is heated to allow the reaction of aluminium and nitrogen to afford aluminium nitride. The aluminium nitride is then directly formed in-situ on the core composed of silicon carbide.

The heating of the atmosphere may be carried out by supplying the silicon carbide core with electrical current. The first component may also comprise a dispersion medium in which the aluminium is dispersed. The coating with the aluminium is accordingly carried out by applying the dispersion. The dispersion medium may be dried with the nitrogen atmosphere and/or evaporated by electrical heating of the core. Alternatively metallic aluminium may be sputtered onto the core or deposited from the gas phase.

What is important in all coating processes is that the electrical connections are not coated because AlN is an electrical insulator. Electrical connection would thus no longer be possible. A first option to prevent this consists of providing the core with the first and with the second electrical connection and then providing it with the protective coating and subsequently with the catalyst coating. Care must be taken to ensure that the electrical connections are not coated. To this end the connections may for example be masked during the coating.

Alternatively the core is provided with a first and a second electrical connection only once the core has been coated with the protective coating. In this case the core may for instance be completely coated and the coating is then partially removed from the core again to uncover the electrical connections.

The invention thirdly provides a heating element obtainable by the process according to the invention. This is characterized by the described layer construction and by the layer quality and adhesion produced by the coating process.

The heating element according to the invention may be used for heating endothermic chemical reactions that are catalyzable with platinum. Temperatures up to about 1400° C. are possible.

The heating element is preferably employed in the production of hydrocyanic acid or other nitriles.

The invention thus likewise provides for the use of the heating element according to the invention in the production of hydrocyanic acid.

The heating element is in particular used in an electrically heated BMA process, wherein hydrocyanic acid is synthesized from ammonia and methane in the absence of oxygen.

The invention therefore further provides a process for producing hydrocyanic acid using the heating element according to the invention. Such a process comprises at least the steps of:
a) providing a reactor containing at least one heating element according to the invention;
b) supplying the reactor with a reactant gas mixture containing at least ammonia and methane, wherein the reactant gas mixture has an oxygen content of less than 2% by volume or wherein the reactant gas mixture is free from oxygen;
c) supplying the heating element with electrical current;
d) withdrawing a product gas mixture containing at least hydrocyanic acid from the reactor.

Due to the low oxygen content or the preferred absence of oxygen the process is not an Andrussow process but rather an electrically heated BMA process, referred to as an E-BMA process.

In addition to hydrocyanic acid the product gas mixture may also contain byproducts or unconverted reactants.

It is preferable when the process is heated exclusively electrically, i.e. no thermal energy to enable the endothermic reaction is provided. This does not rule out preheating the reactants with non-electrical heat sources outside the reactor.

It is preferable when the reaction is catalysed exclusively with the electrical heating element. This means that apart from the catalyst system applied on the heating element according to the invention no further catalysts are provided in the reactor.

It is also possible to provide two or more heating elements according to the invention in the reactor.

### DESCRIPTION OF FIGURES

The invention shall now be elucidated in detail with reference to drawings. In the figures:

FIG. 1 shows: Inventive heating element, schematic, sectional;

FIG. 2 shows: inventive process mode, schematic.

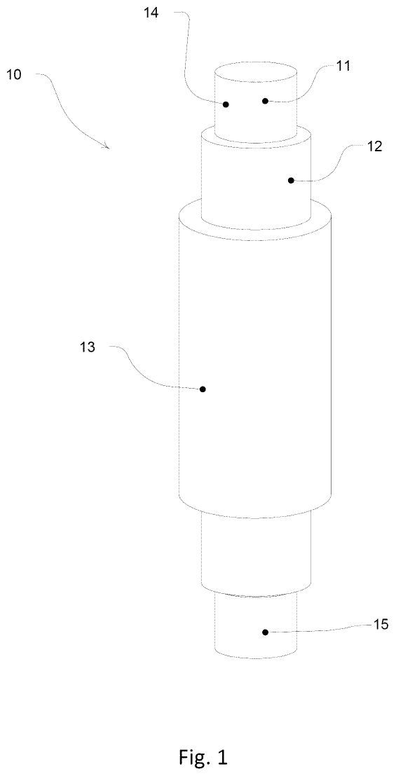

The inventive heating element 10 is shown in FIG. 1. It comprises a core 11 composed of silicon carbide (SIC). A protective coating 12 composed predominantly of aluminium nitride (AlN) has been applied thereto. A catalyst system 13 containing platinum (Pt) has been applied to the protective coating 12. The catalyst system 13 is separated from the core 11 by the protective layer 12.

The protective coating 12 and the catalyst system 13 completely encompass the core 11 with the exception of two sites at which the heating element 10 comprises a first electrical connection 14 and a second electrical connection 15. The protective coating 12 adheres non-detachably to the core 11 and the catalyst system 13 adheres non-detachably to the protective coating 12.

Alternatively to the embodiment shown in FIG. 1 the core 11 may also be in the form of a hollow tube which is initially provided with the protective coating 12 and subsequently provided with the catalyst system 13 on its inner surface (not shown). The catalytically active coating is accordingly inside the tube.

The two connections 14, 15 are used to contact the heating element 10 with an electrical voltage source 17 (not shown in FIG. 1). The heating element may also have a third electrical connection (not shown) to allow three-phase operation thereof.

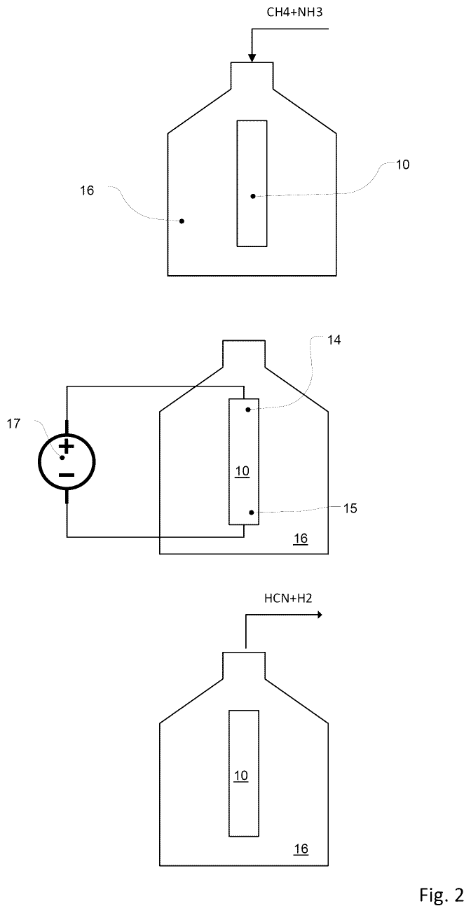

FIG. 2 shows the process sequence schematically in three steps from top to bottom:

A reactor 16 with the heating element 10 arranged therein is provided and filled with reactant gas mixture (NH₃+CH₄). The heating element 10 is connected to an electrical voltage source 17 and supplied with electrical voltage. Due to the OHMic resistance of the silicon carbide the core 11 becomes hot and heats the reactor 16 from inside. The reactant gas mixture (NH₃+CH₄) is converted into the product gas mixture (HCN+H₂) using platinum present in the catalyst system 13. The primary product gas mixture (HCN+H₂) is withdrawn from the reactor 16 together with the byproducts and the unconverted reactants.

EXAMPLES

The invention shall now be elucidated in detail with reference to examples.

### Motivation

The objective of the experiment is electrical heating of a reactor 16 for producing HCN to temperatures greater than 1100° C. using SiC heating elements, wherein the heating elements 10 are arranged directly in the reaction gas phase. Since the reaction will thus proceed directly at the surface of the heating elements 10, said surface must be coated with catalyst. At the required temperatures the main component of the BMA catalyst platinum and the element material (SiC) undergo alloy formation, thus considerably disrupting the BMA reaction. To avoid formation of this alloy a protective layer was applied to the heating elements 10 in order thus to avoid contact between Pt and Si. AlN (aluminium nitride) was identified as a suitable blocking layer since the coefficient of expansion is in a comparable range between AlN and SiC.

### Experimental Description

In the experiment the system SiC/AIN was investigated in an experimental reactor. An SiC tube having dimensions of ØE=22 mm, Øl=17 mm, L=2100 mm was coated with AlN. To this end AIN was incorporated into a lacquer matrix containing binder, adhesion promoter, rheology additive and solvent. Coating of the inner surface of the tube is carried out in an adapted immersion process. This comprises sealing one end of the tube with a stopper and introducing primer via the second opening. After sealing the second opening, likewise with a stopper, the inner surface is completely coated by rotating the tube. Excess material is subsequently poured out and the primer dried by passing nitrogen through the tube. After a drying time of 24 h the tube was installed in the experimental reactor and the primer baked in the nitrogen stream (heating rate: 100 K/h, target temperature 1150° C., holding time 2 h). After complete cooling, to achieve a sufficient layer thickness, the inner surface of the tube was recoated with primer and the baking operation repeated.
Application amount: 28.6 g
Layer thickness: about 30 μm (calculated).

Subsequently the tube was coated with the platinum-containing catalyst and the synthesis performance in the experimental reactor 16 investigated. The main objective of the experiment was assessing the synthesis behaviour over the run duration. To this end the plant was operated at a reactant gas loading of about 60 mol/h with an ammonia excess at a temperature of 1180° C. over a period of about 170 h.

### Result

Over a relatively long period the yields were greater than 80% based on ammonia and greater than 90% based on methane and thus at a comparable level to a standard tube composed of corundum. A comparative synthesis behaviour to a standard tube was observed over the period investigated.

### Coating Process

The selected coating process for the primer is the simplest option for coating a single tube at low cost and complexity. Coating by a spray process is likewise possible and was successfully practised.

### REFERENCE NUMERALS

10 Heating element
11 Core
12 Protective coating
13 Catalyst system
14 First electrical connection
15 Second electrical connection
16 Reactor
17 Voltage source
AlN Aluminium nitride
CH4 Methane
CH4+NH3 Reactant mixture
H2 Hydrogen
HCN Hydrocyanic acid
HCN+H2 Product mixture
NH3 Ammonia
Pt Platinum
SiC Silicon carbide

1. A heating element at least comprising:
a) a first electrical connection;
b) a second electrical connection;
c) a solid or hollow core containing silicon carbide, wherein the solid or hollow core electrically connects the first electrical connection at least to the second electrical connection;
d) a protective coating applied to the solid or hollow core;
e) a catalyst system applied to the protective coating, wherein the catalyst system contains platinum,
wherein
the protective coating contains aluminum nitride.

2. The heating element according to claim 1, wherein the catalyst system is applied exclusively to the protective coating .

3. The heating element according to claim 1, wherein a volume v₁ of the protective coating and/or a volume v₂ of the catalyst system is smaller than a volume v₀ of the solid or hollow core.

4. A process for producing a heating element, the process comprising at least:
a) providing a solid or hollow core containing silicon carbide;
b) providing a coating composition containing aluminum and nitrogen;
c) providing a catalyst system containing platinum;
d) coating the solid or hollow core with the coating composition to obtain a protective coating containing aluminum nitride adhering to the solid or hollow core;
e) coating the protective coating with the catalyst system so that the catalyst system adheres to the protective coating.

5. The process according to claim 4, wherein the coating composition is a dispersion containing a dispersion medium and aluminum nitride dispersed therein.

6. The process according to claim 5, comprising:
spraying the dispersion onto the solid or hollow core and
subsequently drying the dispersion.

7. The process according to claim 5, comprising:
immersing the solid or hollow core in the dispersion and
subsequently drying the solid or hollow core.

8. The process according to claim 4, wherein the coating composition is a system comprising two components, namely a first component containing aluminum and a second component containing nitrogen and wherein the aluminum and the nitrogen are reacted to afford aluminum nitride in presence of the solid or hollow core.

9. A process, comprising:
employing a heating element according to claim 1 in the production of nitriles.

10.-11. (canceled)

12. A process for producing nitriles, the process comprising:
a) providing a reactor containing at least one heating element;
b) supplying the reactor with a reactant gas mixture containing at least ammonia and methane, wherein the reactant gas mixture has an oxygen content of less than 2% by volume or wherein the reactant gas mixture is free from oxygen;
c) supplying the heating element with electrical current;
d) withdrawing a product gas mixture containing at least hydrocyanic acid from the reactor;
wherein
the provided heating element is a heating element according to claim 1.

13. The process according to claim 12, wherein the produced nitrile is hydrocyanic acid.

14. The process according to claim 12, comprising:
providing heat energy and catalyzing of an endothermic reaction with the heating element.
